(19) United States
(12) Patent Application Publication
(10) Pub. No.: US 2026/0327959 A1
(43) Pub. Date: Oct. 22, 2026

(54) SHOWER VALVE WITH LEAK DETECTION

(71) Applicant: Delta Faucet Company, Indianapolis, IN (US)

(72) Inventor: David Lee, Westfield, IN (US)

(21) Appl. No.: 19/649,787

(22) Filed: Apr. 16, 2026

Related U.S. Application Data
(60) Provisional application No. 63/791,169, filed on Apr. 18, 2025.

(51) Int. Cl. E03C 1/05; G01M 3/18

(52) U.S. Cl. CPC E03C 1/055; G01M 3/18

(57) ABSTRACT

An electronic shower system including a valve assembly fluidly coupled to a water supply. The valve assembly directs water from the water supply to a predefined space along a path to a showerhead. Electrical probes are positioned in association with the valve assembly. A controller is in electrical communication with the electrical probes. The controller detects when water has leaked out of the predefined space in the valve assembly and has electrically interconnected the electrical probes. The controller informs a human user or service personnel of the detected leaked water.

### CROSS-REFERENCE TO RELATED APPLICATION

The present application claims priority to U.S. Provisional Patent Application Ser. No. 63/791,169, filed Apr. 18, 2025, the disclosure of which is expressly incorporated hereby by reference.

### BACKGROUND AND SUMMARY OF THE INVENTION

The present invention relates generally to an electronic shower system and, more particularly, to an electronic shower system including leak detection capabilities.

Leaks behind the walls of showers are not uncommon, have potential high consequence to users and manufacturers alike, and may be difficult to detect before a problem escalates to significant property damage or mold ingress. Leak detectors in shower systems, however, are not state of the art. The integration of leak detectors in a shower valve, such as a valve cartridge, a valve body or a trim, is not known.

The present disclosure provides an integrated leak sensor in a digitally controlled shower valve that enables the user and/or manufacturer to be alerted via communication through a user interface, or through wireless communications to an external network or external device.

According to an illustrative embodiment of the present disclosure, a shower valve includes two normally open contacts or probes that are metallic or otherwise electrically conductive. The probes are illustratively located within a valve assembly and/or within the metallic or otherwise electrically conductive “rough” or body receiving the valve assembly, in a space that is not normally wet during operation of the shower. When the space receiving the probes becomes flooded with water in the event of a leak, the probes become electrically connected by the leaked water, which closes a circuit on a valve controller. Alert messages informing about the leak can be communicated to the user and/or to service personnel. Further, secondary seals may be incorporated to fully retain any leaks but alert the user of potential failures, or to indicate that the valve has been installed incorrectly or needs timely replacement from wear and/or failure.

Alternatively, the probes may be placed in the trim (e.g., escutcheon) that typically surrounds the valve rough and valve assembly and creates a secondary seal. The probes may connect to the valve controller and/or user interface. Thus, if the trim develops a leak path into the fixture (as opposed to behind the wall), the user and/or service personnel may be notified, or the valve may be closed to prevent further leakage.

The illustrative shower valve and/or shower trim uses existing control board space to create two probes/contact points that close an electrical circuit when wetted with water from a leak, enabling a signal to pass between the two probes and within the control board (e.g., printed circuit board (PCB)). In another illustrative example, the shower valve and/or shower trim may use an electrical ground for a thermistor as a single point of contact with water, and if water bridges between the PCB and the valve body outside the intentionally wetted surface, the water closes the circuit in the PCB and the leak is thereby detected.

While most leaks follow gravity, in a further illustrative example, the valve assembly and/or shower trim may come into electrical communication with the valve rough through probe contact. A series of probes may be included circumferentially around the valve, further increasing the probability of water leak detection by eliminating the need to orient the detector to the leakage.

According to an illustrative embodiment of the present disclosure, an electronic shower system includes a valve assembly fluidly coupled to a water supply. The valve assembly directs water from the water supply to a predefined space along a path to a showerhead. A first electrical probe and a second electrical probe are operably coupled to the valve assembly. A controller is in electrical communication with the first electrical probe and the second electrical probe. The controller detects when water has leaked out of the predefined space in the valve assembly and has electrically interconnected the first electrical probe and the second electrical probe. An indicator is in communication with the controller and is configured to provide an alert of the detected leaked water.

According to another illustrative embodiment of the present disclosure, an electronic shower system includes a valve assembly configured to be fluidly coupled to a water supply and to confine water supply to a predefined space along a path to a showerhead. A first electrical probe and a second electrical probe are positioned in association with the valve assembly. The first electrical probe is on a thermistor disposed within the predefined space. A controller is in electrical communication with the first electrical probe and the second electrical probe. The controller is configured to detect when water has leaked out of the predefined space in the valve assembly and has electrically interconnected the first electrical probe and the second electrical probe, and inform a human user or service personnel of the detected leaked water.

According to yet another illustrative embodiment of the present disclosure, a valve assembly is configured to be fluidly coupled to a water supply and to confine water from the water supply to a predefined space along a path to a showerhead. A housing substantially surrounds the valve assembly. A first electrical probe and a second electrical probe are positioned outside of the valve assembly, at least one of the first and second electrical probes being attached to the housing. A controller is in electrical communication with the first and second electrical probes. The controller is configured to detect when water has leaked out of the predefined space and has electrically interconnected the first and second electrical probes, and inform a human user or service personnel of the detected leaked water.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is an upper perspective view of an illustrative electronic shower system of the present disclosure;

FIG. 2 is an upper, front perspective view of an illustrative electronic valve assembly of the present disclosure for use with the electronic shower system of FIG. 1;

FIG. 3 is a partially exploded upper, front perspective view of the illustrative electronic valve assembly of FIG. 2;

FIG. 4 is a cross-sectional view of the electronic valve assembly of FIG. 2 along line 4-4;

FIG. 5 is an enlarged view of area 5 in FIG. 4;

FIG. 6 is an upper perspective cross-sectional view of the electronic valve assembly of FIG. 2 along line 6-6;

FIG. 7 is an enlarged view of area 7 in FIG. 6;

FIG. 8 is an upper perspective view, with a partial cut-away, of another illustrative leak detection system of an illustrative electronic shower system of the present disclosure;

FIG. 9 is a perspective cross-sectional view of the leak detection system of FIG. 8 along line 9-9;

FIG. 10 is an enlarged view of area 10 in FIG. 9;

FIG. 11 is a cross-sectional view of the leak detection system of FIG. 8 along line 11-11;

FIG. 12 is an enlarged view of area 12 in FIG. 11; and

FIG. 13 is a perspective, partially exploded cross-sectional view of the leak detection system of FIG. 8 along line 13-13.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner

### DETAILED DESCRIPTION OF THE DRAWINGS

The embodiments of the disclosure described herein are not intended to be exhaustive or to limit the disclosure to the precise forms disclosed. Rather, the embodiments described herein enable one skilled in the art to practice the disclosure.

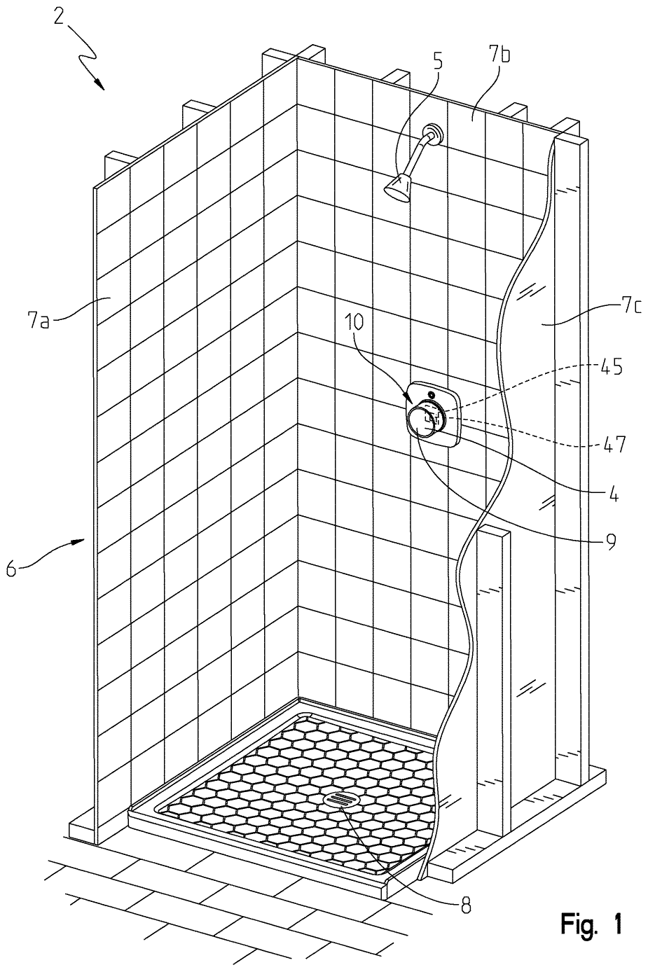

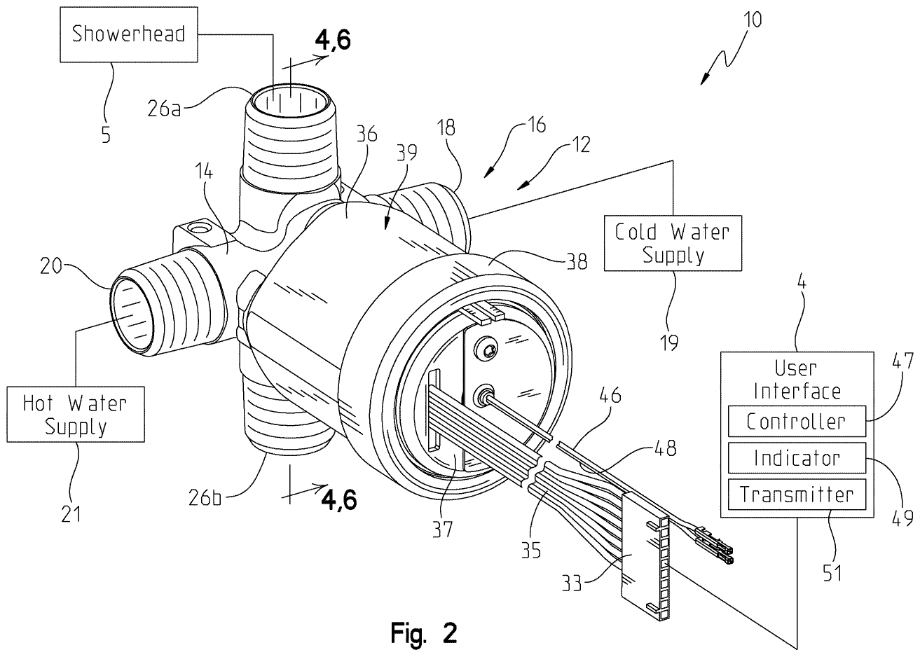

With reference initially to FIGS. 1 and 2, an illustrative electronic shower system 2 of the present disclosure includes an electronic user interface 4 by which a human user can control the flow rate and the temperature of water emitted by a fluid delivery device, such as a showerhead 5 within a shower enclosure 6. The shower enclosure 6 may be defined by walls 7a, 7b, 7c extending upwardly from a base 8.

The illustrative user interface 4 may be coupled to rear wall 7b of the shower enclosure 6 and include a touch-sensitive screen (“touch screen”) 9 for receiving manual inputs from the user and for displaying menus, messages and other information to the user. In other illustrative embodiments, the touch-sensitive screen 9 of the user interface 4 may be replaced by other devices, such as one or more push buttons, rotatable dials, switches, etc. The user interface 4 may include a printed circuit board (PCB) 45 that is electrically connected by an electrical connector 33 and an electrical cable 35 (FIG. 2) to an illustrative leak detection system 10 of the present disclosure that includes an electronic shower valve 12.

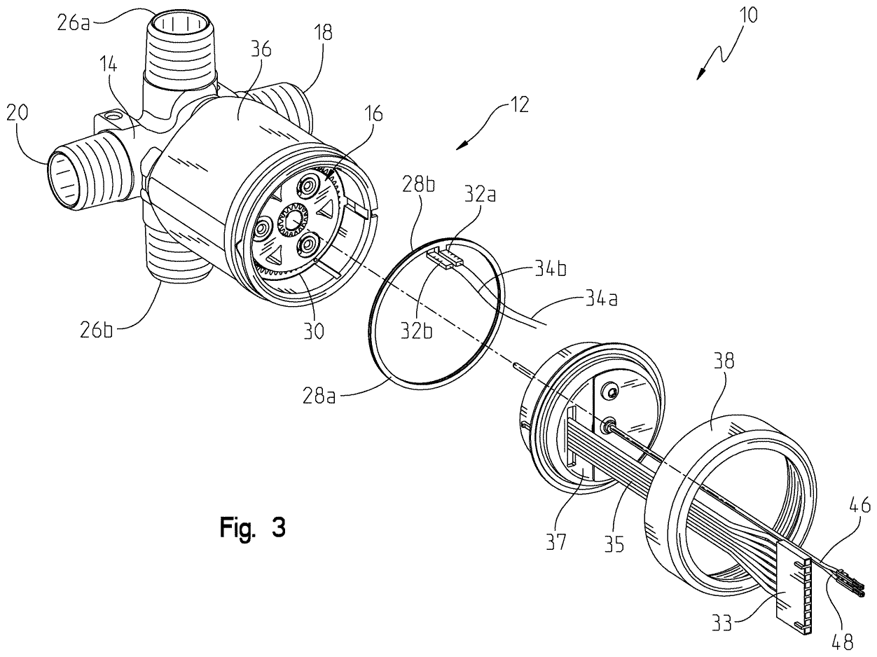

With reference to FIGS. 2 and 3, the illustrative electronic shower valve 12 includes a conventional valve body or fitting 14 of the type supported within the shower wall 7b (FIG. 1) for receiving an illustrative electronic valve assembly, such as a valve cartridge 16. The valve cartridge 16 may be a self-contained removable valve assembly of conventional design (including an open configuration and a closed configuration). Other conventional shower valve assemblies may be substituted therefor.

The illustrative valve body 14 includes a first or cold water inlet 18, which is configured to be fluidly coupled to a conventional cold water supply 19, and a second or hot water inlet 20, which is configured to be fluidly coupled to a conventional hot water supply 21 (FIG. 2). The valve cartridge 16 controls water flow from the cold water inlet 18 and the hot water inlet 20 to a first outlet 26a and/or a second outlet 26b. Illustratively, the first outlet 26a is fluidly coupled to the showerhead 5, while the second outlet 26b may be fluidly coupled to a tub spout (not shown). While the shower valve assembly 16 may be a conventional temperature control valve configured to mix hot water and cold water to control the temperature of outlet water, other types of valve assemblies may be substituted therefor, such as a flow diverter or a flow (only) control valve.

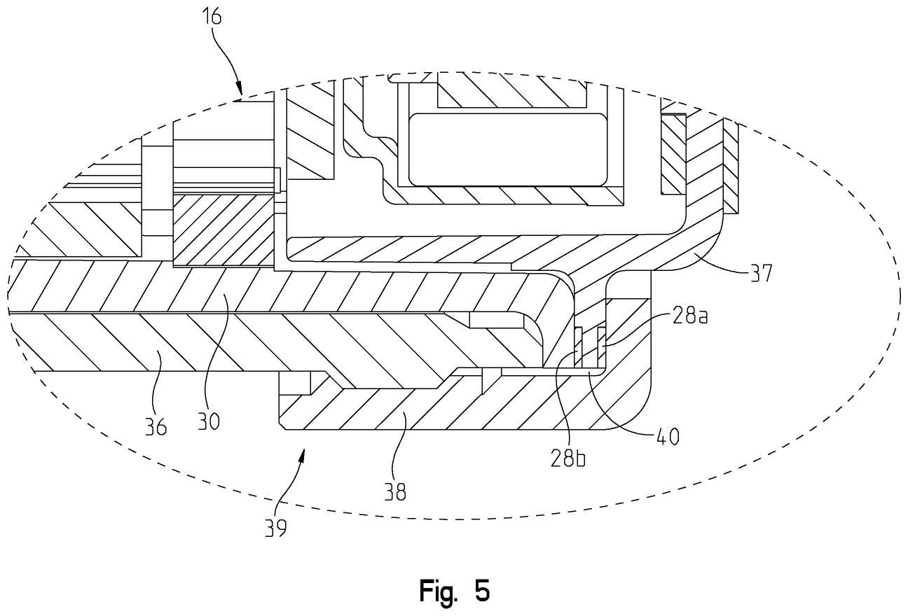

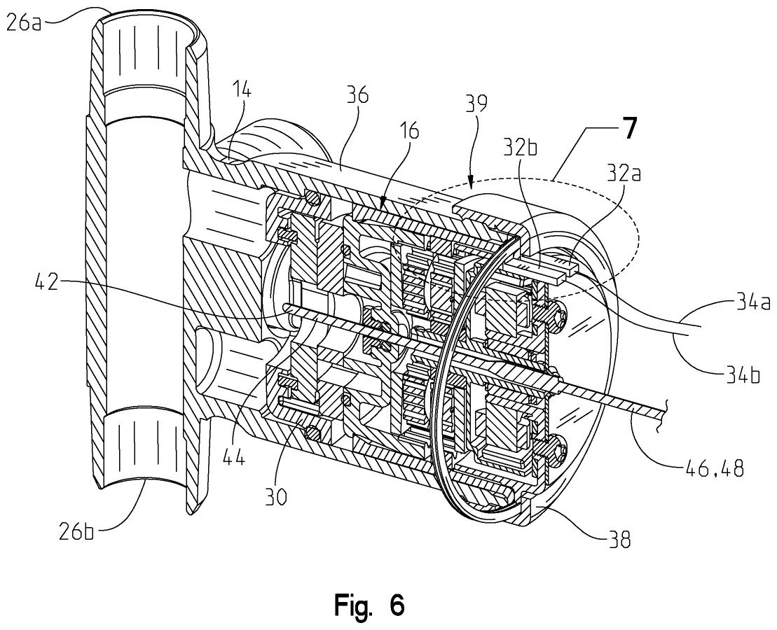

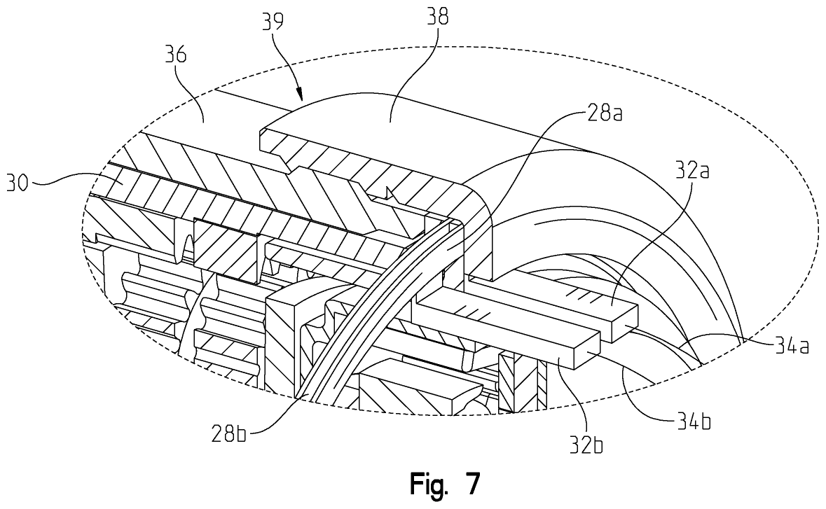

With reference to the illustrative embodiments of FIGS. 3-7, first and second electrically conductive contacts or probes 28a and 28b (shown in an illustrative ring shape) are supported by, and may be integrated into, a housing or body 30 of the valve cartridge 16. The illustrative first and second probes 28a and 28b are shown in the form of axially spaced rings. The first electrically conductive probe 28a has a lead 32a, and the second electrically conductive probe 28b has a lead 32b. The leads 32a and 32b may be electrically connected to respective electrical conductors 34a and 34b that may be included in electrical cable 35. Through cable 35 and connector 33, the conductors 34a and 34b may be electrically connected to the PCB 45 to close a circuit, and a controller 47 (e.g., a microprocessor) on the PCB 45 may notify the user via the user interface 4, or wirelessly notify service personnel, when conductors 34a and 34b have been electrically connected together, such as by leaked water.

Illustratively, the user interface 4 may include an indicator 49 (e.g., a light and/or an audible alarm) and/or a wireless transmitter 51 (FIG. 2). The conductors 34a and 34b may be directly and fixedly connected to respective pins on the integrated circuit board 45 of the controller 47 of the user interface 4. The controller 47 may detect when the two pins have been electrically connected to each other, such as by water that has leaked, through a known process referred to as “continuity testing.”

The illustrative valve body 14 includes a cylindrical outer shell 36 receiving the valve cartridge 16 and is capped by an end cap 37 secured to the valve body 14 via a circular bonnet nut 38. More particularly, the bonnet nut 38 may be threadably coupled to the outer shell 36. The shell 36 and the bonnet nut 38 may be both made of an electrically conductive material (e.g., a metal) and are electrically coupled together. The valve body 14 and the bonnet nut 38 may be collectively referred to as a rough 39. The valve cartridge 16 is illustratively received within the valve body 14, which includes the cold water inlet 18, the hot water inlet 20 and the outlets 26a and 26b. The body 30 of the valve cartridge 16 may also made of the same electrically conductive metal as the valve body 14.

With further reference to the illustrative embodiments of FIGS. 3-5, the first probe 28a is in direct contact with the bonnet nut 38. The first probe 28a being in contact with the rough 39 enables any conductive bridge between probe 28b and the rough 39 to close the electrical circuit. For example, if leaked water accumulates in space 40, then the leaked water may electrically interconnect the second probe 28b and the bonnet nut 38, thereby electrically interconnecting first and second probes 28a and 28b, closing the circuit and sensing the water leak. Illustratively, the space 40 is defined between the end cap 37 and the bonnet nut 38.

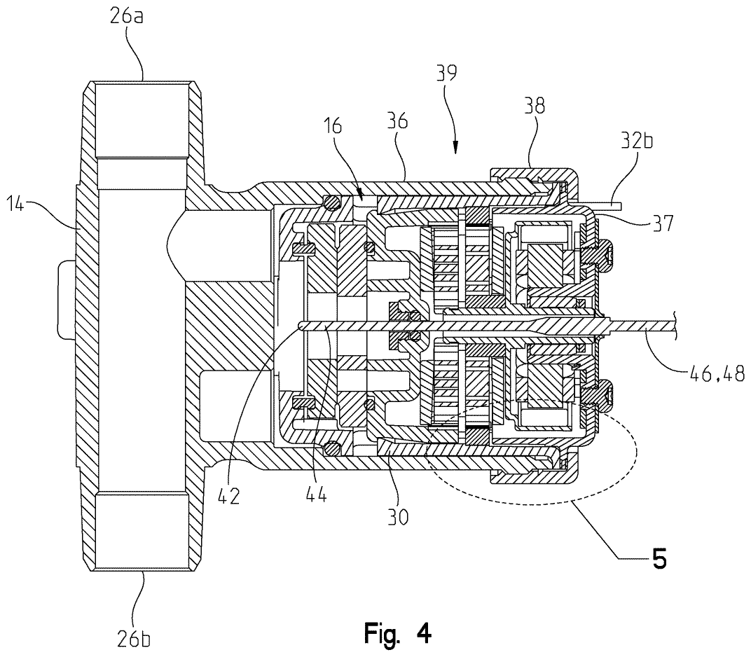

In another illustrative embodiment, the first probe 28a that is permanently connected to the rough 39 is eliminated. Instead, the first probe 28a is replaced by the electrical ground terminal of a temperature sensor 42 (FIG. 4). The temperature sensor 42, illustratively a thermistor, is configured to detect the temperature of water passing through the outlet 26. The thermistor 42 may be of conventional design as including a sensing probe 44 coupled to an electrical ground wire 46 and a positive wire 48 that are shown as separate from wiring cable 35 in FIGS. 2-3, but that may alternatively be included within cable 35. Illustrative electronic shower valves including a temperature sensor are detailed in U.S. Patent Application Publication No. 2021/0388584 to Thomas et al., and PCT International Patent Application Publication No. WO 2025/145163 to Veros et al., the disclosures of which are expressly incorporated herein by reference.

The electrical ground terminal of the thermistor 42 is disposed in the normal water flow whenever the shower is operating. When a leak occurs, the leaked water collects in space 40 and comes into contact with the second probe 28b. The normally flowing water and the leaking water conjunctively provide a continuous electrically conductive path between the thermistor 42 and the second probe 28b. Thus, when the controller 47 on the PCB 45 senses that the thermistor 42 and the second probe 28b have become electrically connected by the water, it is concluded by the controller 47 that there is a leak, and the user and/or service personnel are notified (illustratively, via the indicator 49 and/or the transmitter 51).

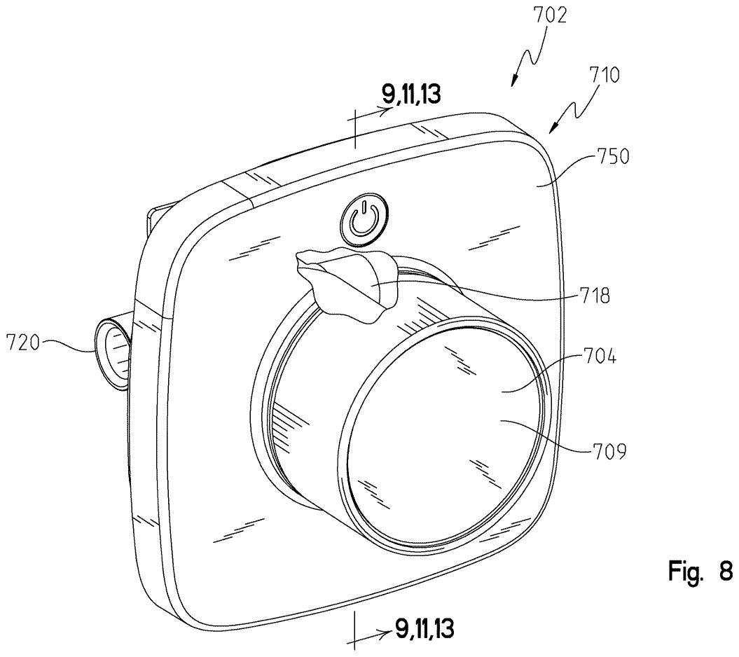

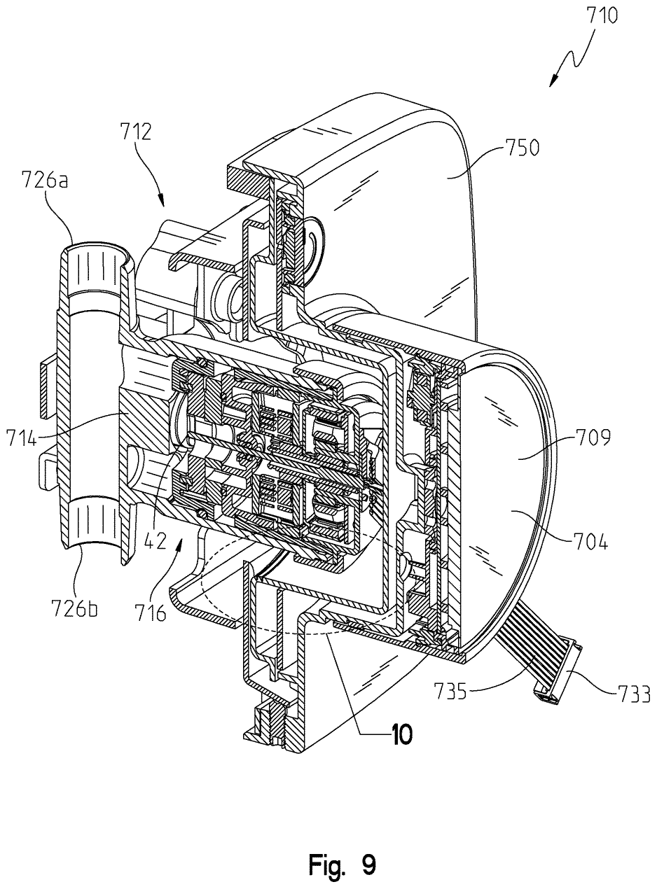

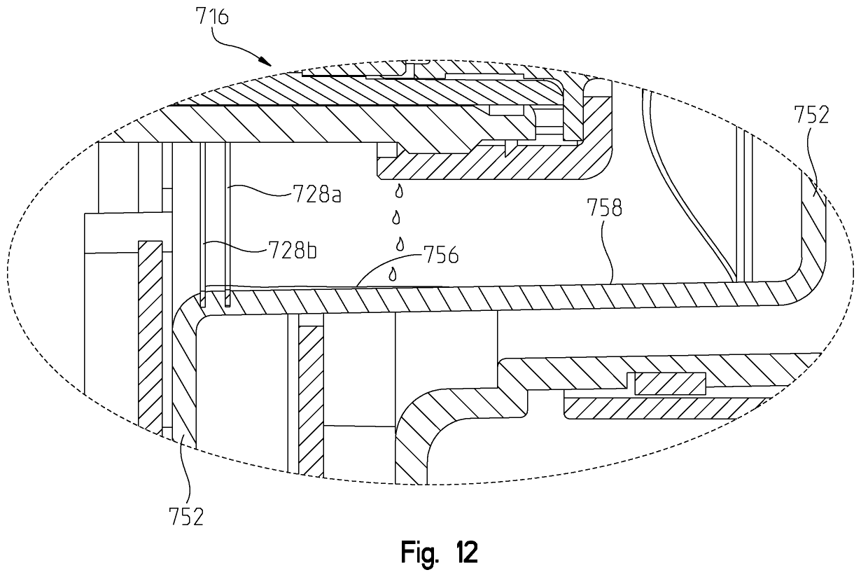

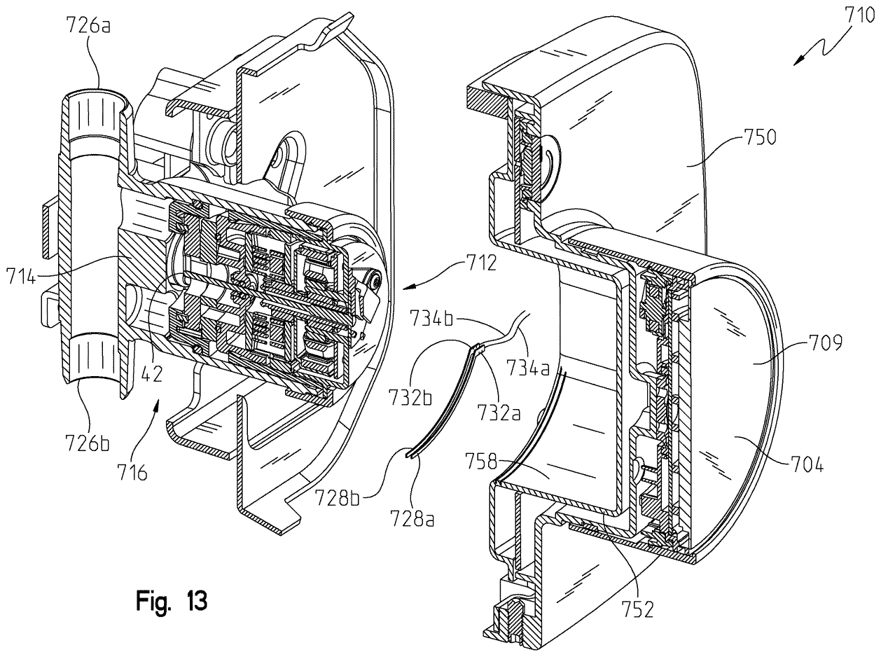

Another illustrative embodiment of the present disclosure is shown in FIGS. 8-13 wherein a leak detection system 710 for an electronic shower system includes an electronic user interface 704 by which a human user can control the flow rate and the temperature of water emitted by a fluid delivery device, such as showerhead 5. An illustrative user interface 704 includes a touch screen 709 and is surrounded by an escutcheon 750. The illustrative leak detection system 710 further includes an electronic shower valve 712 having a valve body or fitting 714 of the type supported within a shower wall for receiving an illustrative electronic valve cartridge 716. The valve cartridge 716 controls water flow from a cold water inlet 718 and a hot water inlets 720 to a first outlet 726a and/or a second outlet 726b (FIGS. 8 and 9). Illustratively, the first outlet 726a is fluidly coupled to the showerhead 5, while the second outlet 726b may be fluidly coupled to a tub spout (not shown).

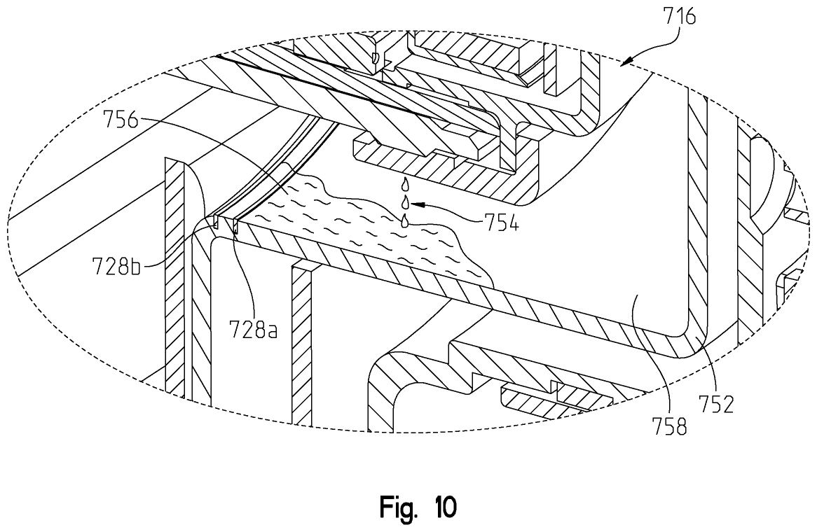

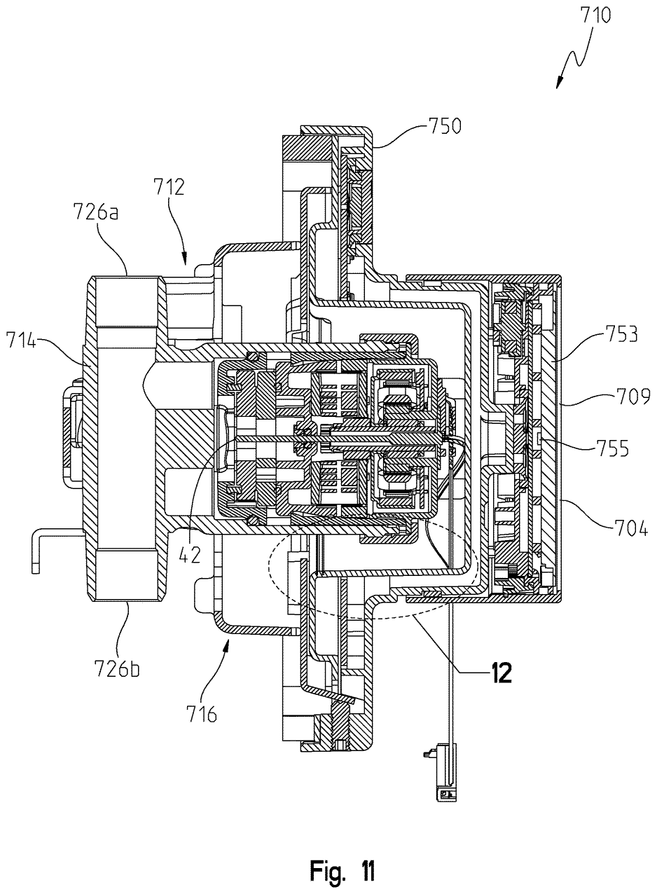

With reference to FIGS. 10, 12 and 13, first and second electrically conductive probes 728a and 728b (shown in an illustrative arcuate shape) are supported by, and may be integrated into, a non-electrically conductive interior wall 752 of escutcheon 750. The first probe 728a and the second probe 728b each has a respective lead 732a and 732b that may be connected to a respective electrical conductor 734a and 734b. The electrical conductors 734a and 734b may be included in an electrical cable 735. Through a connector 733, the cable 735 and the associated conductors 734a and 734b, the probes 728a and 728b may be connected to a PCB 753 (FIG. 11) to close a circuit, and a controller 755 (e.g., a microprocessor) on the PCB 753 may notify the user via the user interface 704, or wirelessly notify service personnel, when probes 728a, 728b have been electrically connected together, such as by leaked water. As detailed above, the user interface 744 may include an indicator (e.g., a light or an audible alarm) and/or a wireless transmitter.

The conductors 734a and 734b may be directly and fixedly connected to respective pins on the integrated circuit of the controller 755. The controller 755 may detect when the two pins have been electrically connected to each other, such as by water that has leaked, through a known process referred to as “continuity testing.”

During use, in the event of a water leak, the water may drip down from the valve cartridge 716, as shown at 754 in FIG. 10. The dripping water may collect and form a pool 756 on an interior surface 758 of interior wall 752 of escutcheon 750. The pool 756 eventually flows over both probes 728a, 728b, thereby electrically interconnecting the probes 728a, 728b. Thus, when the controller on the PCB 753 senses that the probes 728a, 728b have become electrically connected by the water, it is concluded by the controller 755 that there is a water leak, and the user and/or service personnel are notified.

Although the invention is applied to an escutcheon 750 in the embodiment of FIGS. 8-13, an illustrative embodiment of the invention may also apply to a digital shower box or assembly that does not include an escutcheon. In such a digital shower box, all the valving (e.g., rough, cartridge, some controls) are in a housing, rather than in a traditional escutcheon. The user interface, including a controller, is disposed completely remote from the housing. An example of a digital shower box suitable for applying the invention to is the T1 shower electronic water valve sold by Sedal, S.L.U. of Barcelona, Spain.

Other illustrative embodiments of the invention may apply to a housing or cover as used in a valve body extension of the type disclosed in U.S. Patent Application Publication No. 2026/0049465 to Lee, the disclosure of which is expressly incorporated herein by reference.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An electronic shower system comprising:
a valve assembly configured to be fluidly coupled to a water supply and to direct water from the water supply to a predefined space along a path to a showerhead;
a first electrical probe;
a second electrical probe positioned in spaced relation to the first electrical probe;
wherein the first electrical probe and the second electrical probe are operably coupled to the valve assembly;
a controller in electrical communication with the first electrical probe and the second electrical probe, the controller being configured to detect when water has leaked out of the predefined space in the valve assembly and has electrically interconnected the first electrical probe and the second electrical probe; and
an indicator in communication with the controller and configured to provide an alert of the detected leaked water.

2. The electronic shower system of claim 1, wherein the first electrical probe is supported on a thermistor disposed within the predefined space.

3. The electronic shower system of claim 1, further comprising an electronic user interface in communication with the controller and including the indicator configured to provide the alert of the detected leaked water.

4. The electronic shower system of claim 1, wherein the valve assembly is received within an electrically conductive outer shell, the first probe being electrically connected to the outer shell.

5. The electronic shower system of claim 1, wherein at least one of the first electrical probe and the second electrical probe is loop-shaped and extends around a circumference of the valve assembly.

6. The electronic shower system of claim 5, wherein each of the first electrical probe and the second electrical probe is loop-shaped and extends around a circumference of the valve assembly.

7. The electronic shower system of claim 1, further comprising an escutcheon substantially surrounding the valve assembly, at least one of the first electrical probe and the second electrical probe being attached to the escutcheon.

8. The electronic shower system of claim 7, wherein each of the first electrical probe and the second electrical probe is attached to the escutcheon.

9. An electronic shower system comprising:
a valve assembly configured to be fluidly coupled to a water supply and to confine water from the water supply to a predefined space along a path to a showerhead;
a first electrical probe and a second electrical probe positioned in association with the valve assembly, the first electrical probe being on a thermistor disposed within the predefined space; and
a controller in electrical communication with the first electrical probe and the second electrical probe, the controller being configured to:
detect when water has leaked out of the predefined space in the valve assembly and has electrically interconnected the first electrical probe and the second electrical probe; and
inform a human user or service personnel of the detected leaked water.

10. The electronic shower system of claim 9, further comprising an electronic user interface in communication with the controller and including an indicator configured to inform the human user of the leaked water, wherein the informing is performed in response to a command from the controller.

11. The electronic shower system of claim 9, wherein the second electrical probe is disposed outside of the predefined space.

12. The electronic shower system of claim 11, wherein the second electrical probe is loop-shaped and extends around a circumference of the valve assembly.

13. The electronic shower system of claim 9, further comprising an electronic user interface in communication with the controller and configured to wirelessly inform the service personnel of the leaked water, wherein the informing is performed in response to a command from the controller.

14. An electronic shower system comprising:
a valve assembly configured to be fluidly coupled to a water supply and to confine water from the water supply to a predefined space along a path to a showerhead;
a housing substantially surrounding the valve assembly;
a first electrical probe and a second electrical probe positioned outside of the valve assembly, at least one of the first electrical probe and the second electrical probe being attached to the housing; and
a controller in electrical communication with the first electrical probe and the second electrical probe, the controller being configured to:
detect when water has leaked out of the predefined space and has electrically interconnected the first electrical probe and the second electrical probe; and
inform a human user or service personnel of the detected leaked water.

15. The electronic shower system of claim 14, wherein each of the first and second electrical probes is attached to the housing.

16. The electronic shower system of claim 14, wherein at least one of the first electrical probe and the second electrical probe is shaped arcuately.

17. The electronic shower system of claim 16, wherein each of the first electrical probe and the second electrical probe has an arcuate shape.

18. The electronic shower system of claim 14, further comprising an electronic user interface in communication with the controller and configured to inform the human user or service personnel of the leaked water under control of the controller and in response to a command from the controller.

19. The electronic shower system of claim 18, wherein the electronic user interface includes an indicator configured to inform the human user of the leaked water, and a transmitter configured to wirelessly inform the service personnel of the leaked water.

20. The electronic shower system of claim 14, wherein the housing includes an escutcheon.
